(19) United States
(12) Patent Application Publication
(10) Pub. No.: US 2026/0184183 A1
(43) Pub. Date: Jul. 2, 2026

(54) NON-TRACK-BOUND VEHICLE HAVING A CURRENT COLLECTOR

(71) Applicant: Siemens Mobility GmbH, München (DE)

(72) Inventors: Bastian Blase, Berlin (DE); Florian Bühs, Berlin (DE)

(21) Appl. No.: 18/862,627

(22) PCT Filed: Mar. 28, 2023
(86) PCT No.: PCT/EP2023/057951

§ 371 Date: Nov. 4, 2024

(30) Foreign Application Priority Data
May 3, 2022 (DE) 10 2022 204 337.5

(51) Int. Cl. B60L 5/36; B60L 5/10; B60L 5/26; B60L 5/30

(52) U.S. Cl. CPC B60L 5/36; B60L 5/10; B60L 5/26; B60L 5/30; B60L 2200/18; B60L 2200/36

(57) ABSTRACT

The invention relates to non-track-bound, electrically or hybrid-electrically driven vehicles including a current collector supplying traction energy from a two-pole, electrical overhead line system. The current collector has an erectable supporting frame with a fixed end articulated on a vehicle chassis and a free end articulated to a rocker support. For each contact pole, a rocker with contact strips is resiliently mounted on the rocker support by a spring assembly. A restoring force of the spring assembly has a constant spring characteristic along its compression travel. The spring assembly compression travel includes, successively, a first spring travel with restoring force increasing with a first spring constant, a second spring travel with restoring force remaining constant, and a third spring travel with restoring force rising with a second spring constant greater than the first spring constant, resulting in high contact quality with varying overhead wire heights.

The invention relates to a non-track-bound vehicle according to the preamble of claim 1.

Such a vehicle is known from the published patent application DE 10 2017 203 046 A1. This electrically or hybrid-electrically powered vehicle comprises a current collector for feeding energy from a two-pole overhead line system. The current collector has a pantograph-like frame which carries a rocker with two contact strips for each contact pole. During the journey, the contact strips of each contact pole are in sliding contact with the contact wire assigned to this contact pole, so that electrical energy can be fed in both directly for the traction drive and for charging an energy storage unit on the vehicle. The pantograph-like frame has a lower arm and two upper arms that are connected thereto in an articulated manner. The lower arm has a fixed end at which it is supported on the vehicle in such a manner as to be able to rotate about a transverse axis of the vehicle. Each upper arm has a free end at which it carries the contact strips of a contact pole. A lifting drive is provided to raise the frame, allowing the contact strips to be lifted in a vertical direction.

In the ideal state, the two contact wires of the two-pole overhead contact line system run parallel to each other and centrally above an electrified lane at the same and constant height. Due to road unevenness and rolling movements of the vehicle, but also due to wear and weather influences such as wind and temperature changes, the distances between the two contact wires and the current collector often vary in practice. This can jeopardize the maintenance of an uninterrupted sliding contact during the journey and thus the continuous transmission of traction energy.

In order to reduce the difference between the contact pressure forces with which the contact strips of the two contact poles are pressed against the respective contact wires, adjusting means are known according to a first alternative of the published patent application DE 10 2019 214 959 A1, which have a rotatably mounted deflection pulley with a curve-segment-shaped cable guide and a traction cable guided over the cable guide. The ends of the traction cable are attached in the area of the fixed ends of the support arms. The deflection pulley can be deflected by the lifting drive in such a way that the support arms can be raised by the ends of the traction cable that are deflected by the deflection pulley.

The published patent application DE 10 2019 214 959 A1 shows another alternative in which the frame of the current collector only has a single support arm that can be raised. The support arm has a fixed end, at which it is supported on the vehicle so that it can rotate about a transverse axis of the vehicle, and a free end, to which a rocker support is connected via a joint with an axis of rotation oriented in the longitudinal direction of the vehicle. The rocker support carries on each side of the joint a rocker and the at least one contact strip of the contact poles is arranged on each rocker. Each rocker is mounted on the rocker support via a constant force spring. This allows a force-independent deflection of the rockers relative to the rocker support when the two contact wires are offset in height.

The invention is therefore based on the object of providing a vehicle of the type mentioned at the beginning, in which an energy supply via the current collector is ensured even with varying contact wire positions.

The object is achieved by a vehicle of the generic type having the features specified in the characterizing part of claim 1. A vehicle of the type mentioned at the beginning is not track-bound and is electrically or hybrid- electrically powered and can in particular be a road vehicle, such as a truck or bus. The vehicle has a current collector for feeding traction energy from an electric overhead line system. The overhead line system is designed with two poles and has one contact wire for each contact pole. The current collector has a support frame, for example a pantograph-like support frame, which can be raised. The support frame is supported on a vehicle chassis in an articulated manner by a fixed end. A free end of the support frame is connected in an articulated manner to a rocker support. The joints of the support frame preferably have axes of rotation parallel to a transverse axis of the vehicle. A rocker with contact strips is resiliently mounted on the rocker support via at least one spring assembly for each contact pole.

According to the invention, a restoring force of the spring assembly has a continuous spring characteristic curve on its spring travel, wherein the spring travel of the spring assembly has a first spring travel, a second spring travel and a third spring travel in succession. On the first spring travel, a restoring force increases with a first spring constant, preferably linearly. On the second spring travel, the restoring force remains constant, preferably at a preset constant force value. On the third spring travel, the restoring force increases with a second spring constant that is greater than the first spring constant. This results in a spring assembly with a self-centering spring characteristic curve and a constant force range under partial pre-stressing. The spring assembly compensates for variations in both vibration movements of the vehicle in the higher-frequency variation range and height differences of the contact wires in the low-frequency variation range.

With this compensation, only the masses of the rockers have to be moved and not the entire support frame. The resulting higher dynamics improve the contact quality of the contact strips to the contact wires and thus increase the availability of the overhead contact line system. Compared to the prior art described above, the decoupling according to the invention of the spring movements of both rockers eliminates the need for adjusting means for anti-parallel rocker movement; only one rocker needs to be adjusted for each contact wire. In addition, compared to the prior art described at the beginning, many joints and moving parts are eliminated, which allows a more material-saving and cost-conscious production of the current collector of a vehicle according to the invention. The elimination of the deflection pulley and cable guide also makes it easier to mount the current collector on the vehicle.

In an advantageous embodiment of the vehicle according to the invention, the spring assembly comprises a first spring element having the first spring constant, a second spring element exerting a constant force and a third spring element having the second spring constant. The cascaded spring elements form a passive and robust spring assembly with a long service life and durability. The individual spring elements can be replaced separately from each other and allow the individual spring stages to be set to specific characteristics.

In a further advantageous embodiment of the vehicle according to the invention, the first spring element is pre-stressed to an initial force. This allows the restoring force of the spring assembly to be adjusted when the contact wires make contact, which on the one hand prevents damage to the contact strips due to excessively hard contact closure and on the other hand prevents the first spring element from compressing excessively.

In a further advantageous embodiment of the vehicle according to the invention, the first spring travel of the first spring element is limited by first end stops, the second spring travel of the second spring element is limited by second end stops and the third spring travel of the third spring element is limited by third end stops. If the limitation regarding the design of a spring travel due to the block length of the spring element is not sufficient, a spring travel can be limited by end stops interacting with the ends of the spring element. The end of a spring travel is reached when an upper end stop and a lower end stop collide during compression.

In a further advantageous embodiment of the vehicle according to the invention, each rocker is resiliently mounted on the rocker support at its two opposite ends via a respective spring assembly. Due to the mounting via two spring assemblies, compression movements at different contact points of the contact wire on the contact strip can be cushioned more evenly.

In a further advantageous embodiment of the vehicle according to the invention, each rocker carries only one contact strip. Compared to the usual rockers with two parallel contact strips arranged one behind the other in the longitudinal direction of the vehicle, the moving mass of a rocker with only one contact strip is significantly reduced, which improves the dynamics and costs of the current collector.

Further features and advantages of the invention are apparent from the following description of a specific exemplary embodiment with reference to the drawings, in which schematically:

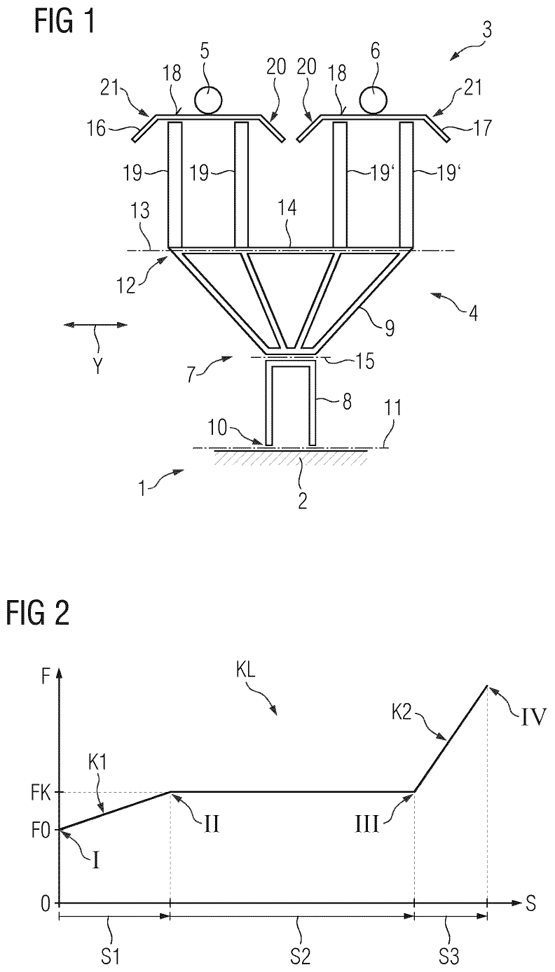

FIG. 1 shows a front view of a current collector according to the invention,

FIG. 2 shows the spring characteristic curve of a spring assembly of the current collector of FIG. 1,

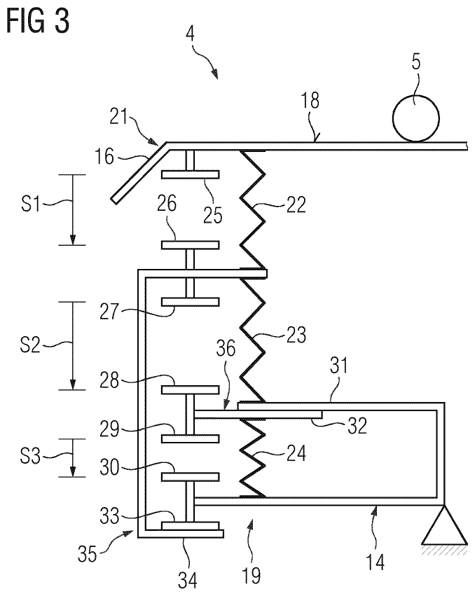

FIG. 3 shows the spring assembly of the current collector of FIG. 1 in a first compressed state,

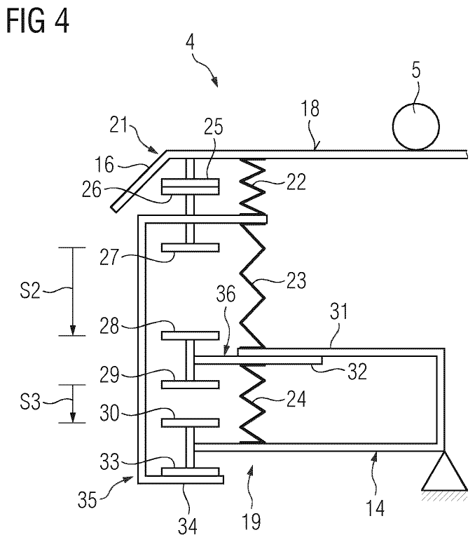

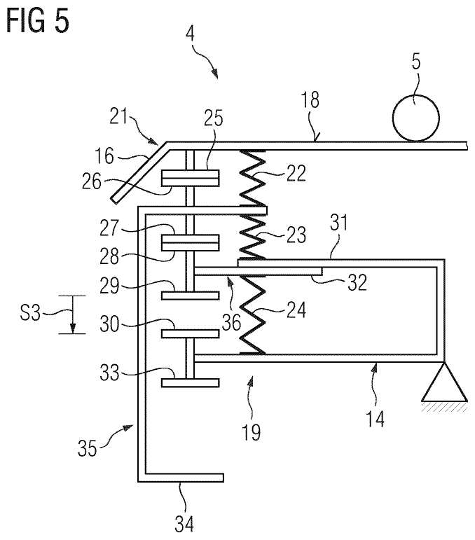

FIG. 4 shows the spring assembly of the current collector of FIG. 1 in a second compressed state,

FIG. 5 shows the spring assembly of the current collector of FIG. 1 in a third compressed state,

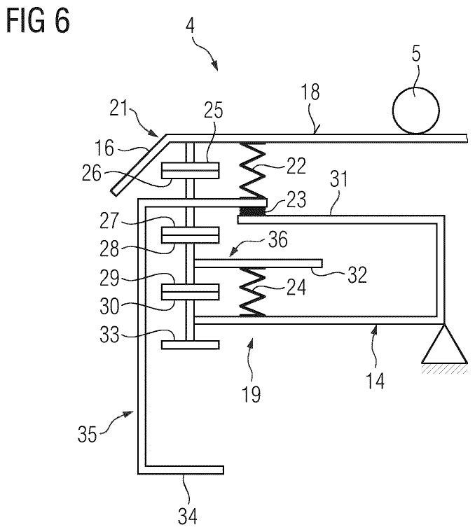

FIG. 6 shows the spring assembly of the current collector of FIG. 1 in a fourth compressed state,

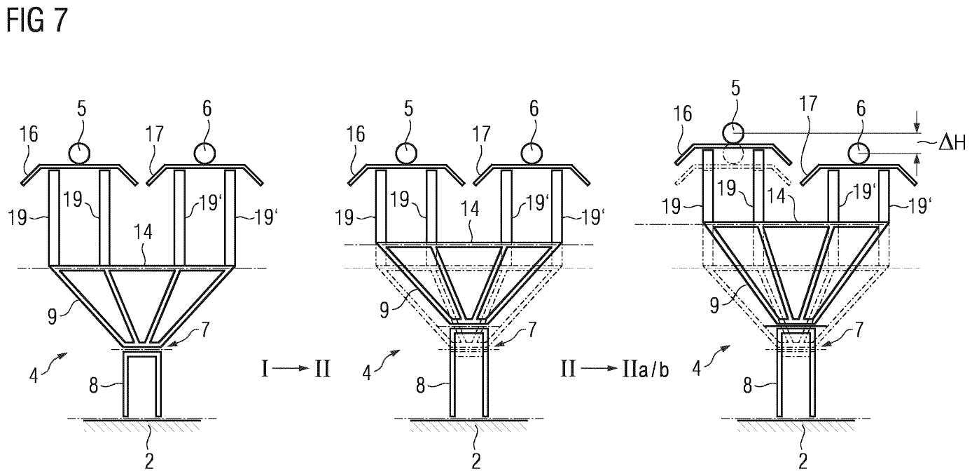

FIG. 7 shows the current collector of FIG. 1 with contacting contact wires at the same height and subsequent height difference,

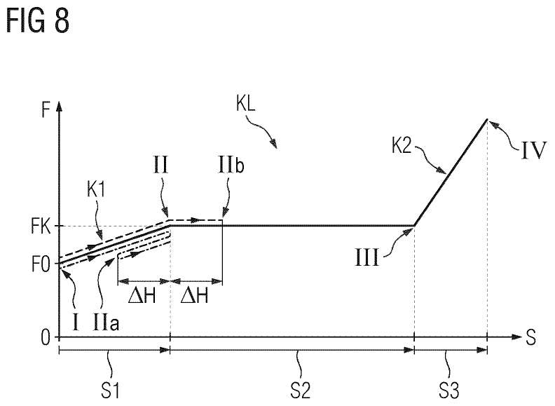

FIG. 8 shows the course of the spring characteristic curve during the process of FIG. 7,

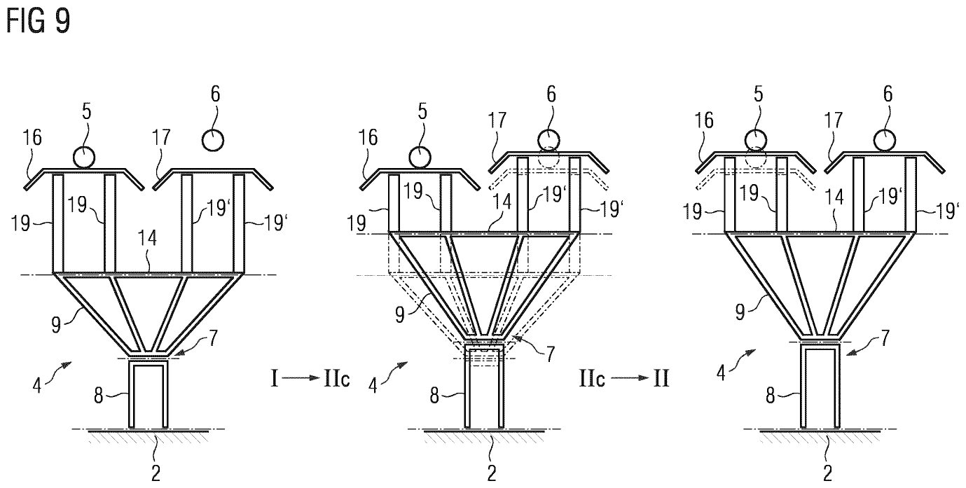

FIG. 9 shows the current collector of FIG. 1 with contacting contact wires at different heights and subsequent height compensation and

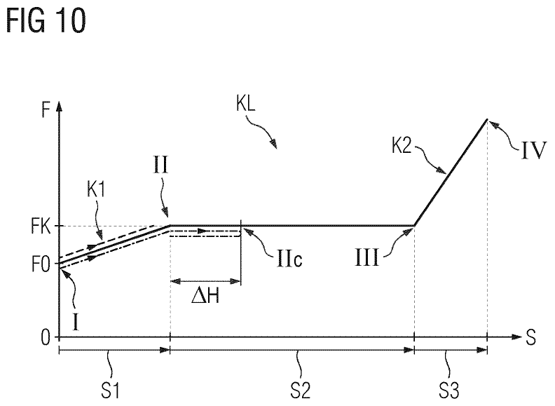

FIG. 10 shows the course of the spring characteristic curve during the process of FIG. 9

FIG. 1 illustrates only a section of a vehicle chassis 2 of a non-track-bound, electrically or hybrid-electrically powered vehicle 1, such as a heavy goods vehicle, or another vehicle part supported directly or indirectly on the vehicle chassis. The vehicle 1 has a current collector 4 for feeding traction energy from an electric overhead line system 3. The overhead line system 3 is designed with two poles and has contact wires 5, 6 in the form of outgoing and return conductors for each contact pole. The current collector 4 has a support frame 7 which can be raised and is designed as a pantograph with a lower arm 8 and an upper arm 9. The support frame 7 is supported on a fixed end 10 located on the lower arm 8 via a base joint 11 on the vehicle chassis 2. A free end 12 of the support frame 7 is located on the upper arm 9 and is connected in an articulated manner to a rocker support 14 via an apex joint 13. The upper arm 9 is connected to the lower arm 8 via an arm joint 15, wherein the axes of rotation of the base joint 11, arm joint 15 and apex joint 13 run parallel to each other and to a transverse direction of the vehicle. A linkage known per se consisting of a coupling rod and pull rod for the pantograph movement is not shown in detail. For each contact pole, a rocker 16, 17 with contact strips 18 is resiliently mounted on the rocker support 14 via respectively two spring assemblies 19 that form the core of the invention. The spring assemblies 19 support a rocker 16 or 17 at its inner end 20 and at its outer end 21. A significant advantage of the spring assemblies 19 is the realization of a compensation of both height differences between the contact wires 5 and 6 and of vibrations of the vehicle 1 by means of a spring assembly 19. Since both types of height variations are compensated in the same spring assembly 19, separate upper arms are not required for the two rockers 16 and 17, but only a common upper arm 9 for both contact poles. The four spring assemblies 19 are simplified and shown disproportionately large to illustrate the spring travel.

According to FIG. 2, FIG. 8 and FIG. 10, a restoring force F of the spring assembly 19 has on its compression travel S a continuous spring characteristic curve KL, which is composed of linear sections along its compression travel S, at the section transitions of which there are kinks but no jumps. Over a first spring travel S1, the restoring force F increases linearly from an initial value F0, which can be set by pre-stressing the spring assembly 19, with a first spring constant K1. In the operating range of this first spring travel S1, the spring assembly 19 compresses to find a force equilibrium between an upwardly directed raising force of a lifting apparatus of the current collector 4, which is provided by the rocker support 14, and a downwardly directed counterforce, which is exerted on the contact strips 18 by a contact wire 5. On a second spring travel S2, the restoring force F remains constant at an adjustable constant force value FK. The operating range of this second spring travel S2 is intended for the situation of different heights between the contact wires 5 and 6. On a third spring travel S3, the restoring force F increases with a second spring constant K2 that is greater than the first spring constant K1. In the operating range of this 32 spring travel S3, the deflected rocker 16 or 17 is re-centered by a more intensely increasing restoring force F.

In FIG. 3 to FIG. 6, the current collector 4 is shown in different compression positions I, II, III and IV (see FIG. 2) of the spring assembly 19 and for the sake of simplicity only a section of the current collector around the spring assembly 19 supporting the outer end 21 of the rocker 16 is shown. The spring assembly 19 comprises a first spring element 22 having the first spring constant K1, a second spring element 23 exerting the constant force FK and a third spring element 24 having the second spring constant K2. The first spring travel S1 of the first spring element 22 is limited by first end stops 25, 26, the second spring travel S2 of the second spring element 23 is limited by second end stops 27 and 28, and the third spring travel S3 of the third spring element 24 is limited by third end stops 29 and 30. Fourth end stops 31 and 32 are also provided, which can pre-stress the third spring element 24. Furthermore, fifth end stops 33 and 34 are provided, which pre-stress the second spring element 23. Further end stops not shown here are also provided, which pre-stress the first spring element 22. The upper first end stop 25 is connected to the rocker 16 in such a way as to prevent displacement. The lower first end stop 26, the upper second end stop 27 and the lower fifth end stop 34 are connected to each other via a first coupling element 35 in such a way as to prevent displacement. The lower second end stop 28, the upper third end stop 30 and the lower fourth end stop 32 are connected to each other via a second coupling element 36 in such a way as to prevent displacement. The upper fourth end stop 31, the lower third end stop 30 and the fifth upper end stop 33 are connected to the rocker support 14 and, above it, to the upper arm 9 in such a way as to prevent displacement. The first spring element 22 33 transmits restoring forces F between the rocker 16 and the 34 first coupling element 35. The second spring element 23 transmits restoring forces F between the first coupling element 35 and the rocker support 14. The third spring element 24 transmits restoring forces F between the second coupling element 36 and the rocker support 14. The arrangement of end stops 25 to 34 and coupling parts 35 and 36 couple the spring elements 22, 23, 24 and limit their maximum deflection during compression.

FIG. 3 to FIG. 6 show the current collector 4 when the spring assembly 19 compresses into the operating points I to IV marked on the characteristic curve KL according to FIG. 2. Until the contact wire 5 is contacted by the contact strip 18 of the rocker 16, the first spring element 22 and the third spring element 24 are relaxed according to FIGS. 3, whereas the second spring element 23 is pre-stressed. An additional pre-stressing of the first spring element 22 is also conceivable, but this is not absolutely necessary. The characteristic curve KL therefore starts at the operating point I with an initial force F0>0 N.

If it is wired to the contact wire 5, the spring element 22 is compressed first, which leads to a linearly increasing restoring force F determined by the first spring constant K1 with increasing compression. Once the first spring travel S1 has been exhausted, this compression is limited either by reaching the block length of the first spring element 22 or, as shown in FIG. 4, by mutual contact between the first end stops 25, 26. The maximum achievable restoring force F at this operating point II is selected to be the same size as the pre-stressed constant force FK of the second spring element 23, which is maintained by the fifth end stops 33, 34. In the event of a stroke difference, i.e. when the contact strip 26 of the other 32 rocker 17 not shown is not yet in contact with its contact 33 wire 6, the second spring element 23 of the spring assembly 19 can continue to compress on the side of the lower hanging contact wire 5 without the restoring force F changing until, after the second spring travel S2 has been exhausted, the second end stops 27, 28 as shown in FIG. 5 meet, thereby reaching the operating point III. From this point, the contact pressure exerted by the lifting drive of the current collector 4 leads to a superimposed restoring force from the second spring element 23 and the third spring element 24, which increases linearly with increasing compression in accordance with the second spring constant K2. This overload range can be used until the third spring travel S3 is exhausted, until the third end stops 29, 30 meet according to FIG. 6 and the operating point IV is reached.

FIG. 7 and FIG. 8 illustrate the mode of action of the spring assemblies 19 and 19′, respectively, when contacting contact wires 5 and 6 at the same height and the height difference AH resulting in the further course of travel. FIG. 7 shows the position of the current collector 4, while FIG. 8 shows the course of the characteristic curve KL of the spring assemblies 19 (left) assigned to the contact wire 5 and the spring assemblies 19′ (right) assigned to the other contact wire 6. The spring assemblies 19 and 19′ are compressed starting at operating point I (FIG. 7, left part) over the linear range of the first spring constant K1 and reach a static force equilibrium at the operating point II (FIG. 7, middle part) at the transition to the constant force range. If the left contact wire 5 now moves upwards, the spring assembly 19 relaxes in the first operating range and reaches the operating point IIa (dotted line in FIG. 8). As a result, the resulting restoring force F of all spring assemblies 19 and 19′ decreases, so that the support frame 7 is pushed further upwards. This upward movement causes the operating point of the spring assembly 19 (left) to move back to the previous operating point II, while the operating point of the spring assembly 19′ moves by AH into the constant force range to IIb.

FIG. 9 and FIG. 10, on the other hand, illustrate the mode of action of the spring assemblies 19 and 19′ when contact is made with contact wires 5 and 6, which already have a height difference AH, but which is equalized in the further course of travel. FIG. 9 shows the position of the current collector 4, while FIG. 10 shows the course of the characteristic curve KL of the spring assemblies 19 (left) assigned to the contact wire 5 and the spring assemblies 19′ (right) assigned to the other contact wire 6. The spring assemblies 19 and 19′ compress differently starting with the first contact at the operating point I (FIG. 7, left part). At the operating point II, the left spring assembly 19 is compressed by its first spring travel S1 and by the height difference AH into the constant force range until the rocker 17 contacts the higher contact wire 6. If the contact wire 5 now moves to the height of the contact wire 6 as the travel progresses, the spring assembly 19 relaxes to the extent of its pre-stressing and as a result moves back from the constant force range of the characteristic curve KL to the operating point II. The other spring assembly 19′ is compressed from the operating point I to the operating point II.

1-6. (canceled)

7. A non-track-bound, electrically or hybrid-electrically powered vehicle (1), comprising:
a current collector for feeding traction energy from a two-pole electrical overhead line system having one contact wire for each contact pole;
said current collector having a rocker support;
said current collector having a support frame configured to be raised, said support frame having a fixed end supported in an articulated manner on a vehicle chassis and a free end connected in an articulated manner to said rocker support;
rockers each having a respective contact strip for each respective contact pole;
at least one respective spring assembly each resiliently mounting a respective one of said rockers with a respective one of said contact strips on said rocker support;
said at least one spring assembly having a compression travel and a restoring force with a continuous spring characteristic curve on said compression travel; and
said compression travel successively having a first spring travel, on which said restoring force increases with a first spring constant, a second spring travel, on which said restoring force remains constant, and a third spring travel, on which said restoring force increases with a second spring constant being greater than said first spring constant.

8. The vehicle according to claim 7, wherein the vehicle is a truck or a bus.

9. The vehicle according to claim 7, wherein said at least one spring assembly includes a first spring element having said first spring constant (K1), a second spring element exerting a constant force and a third spring element having said second spring constant.

10. The vehicle according to claim 9, wherein said first spring element is pre-stressed to an initial force.

11. The vehicle according to claim 9, which further comprises:
first end stops limiting said first spring travel of said first spring element;
second end stops limiting said second spring travel of said second spring element; and
third end stops limiting said third spring travel of said third spring element.

12. The vehicle according to claim 7, wherein said at least one spring assembly includes a plurality of spring assemblies, each of said rockers has two opposite ends, and each of said two opposite ends is resiliently mounted on said rocker support by a respective one of said spring assemblies.

13. The vehicle according to claim 7, wherein each of said rockers carries only one contact strip.
